(19) United States
(12) Patent Application Publication
(10) Pub. No.: US 2010/0275253 A1
(43) Pub. Date: Oct. 28, 2010

(54) COMMUNICATION METHOD, COMMUNICATION SYSTEM, MOBILE NODE, AND COMMUNICATION NODE

(75) Inventors: Jun Hirano, Kanagawa (JP); Chan Wah Ng, Singapore (SG); Mohana Dhamayanthi Jeyatharan, Singapore (SG); Tien Ming Benjamin Koh, Singapore (SG); Chun Keong Benjamin Lim, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/743,805

(22) PCT Filed: Nov. 18, 2008
(86) PCT No.: PCT/JP2008/003355

§ 371 Date: May 19, 2010

(30) Foreign Application Priority Data
Nov. 22, 2007 (JP) 2007-302571

(51) Int. Cl. H04L 9/32; G06F 21/00

(52) U.S. Cl. 726/9

(57) ABSTRACT

There is provided a technique for reducing the number of messages handled in a Return Routability (RR) procedure for performing authentication between a mobile node (MN) and a peer communication node (CN). According to the technique, an MN 1 pairs two or more care-of addresses assigned respectively to one or more interfaces, and sends a CN 3 one or more first messages including a second care-of address by setting a first care-of address in each pair of care-of addresses as a source address. The CN 3 receives the one or more first messages, generates signature tokens for the first and second care-of addresses, and sends one or more second messages including the generated signature tokens to the second care-of address of the MN 2.

### TECHNICAL FIELD

The present invention relates to a communication method in which a peer communication node authenticates a mobile node having two or more interfaces with care-of addresses assigned to each of the two or more interfaces, a communication system, the mobile node, and the communication node.

### BACKGROUND ART

Many devices today communicate with each other using the Internet Protocol (IP). As examples, Internet Engineering Task Force (IETF) has proposed “Mobility Support in IPv6” as shown in Non-Patent Document 1 cited below and “Network Mobility Support” as shown in Non-Patent Document 2 cited below. In Mobile IP, each mobile node has a permanent home domain. When the mobile node is attached to its home network, it is assigned a primary global address known as a home address (HoA). When the mobile node is away from its home network and attached to any other foreign network, it is assigned a temporary global address known as a care-of address (CoA).

The idea of mobility support is such that the mobile node can be reached at the home address even when it is attached to any other foreign network. This is done, as shown in Non-Patent Document 1, with the introduction of an entity called a home agent into the home network. The mobile node registers its care-of-address with the home agent using a message called a binding update (BU) message. As a result of this registration, the home agent generates a binding between the home address and the care-of address of the mobile node. The home agent intercepts a message destined to the home address of the mobile node, and forwards a packet with the message encapsulated therein to the care-of address of the mobile node. Here, “encapsulated” means that a packet is set in a payload of a new packet, and this is known as packet tunneling.

This method can solve mobility problems, but involves the occurrence of a suboptimum route. This is because when the mobile node is communicating with a correspondent node (CN), packets between both have to pass through the home agent. Therefore, Non-Patent Document 1 teaches that the mobile node can send a BU message to the CN. When the CN comes to know a binding between the home address and the care-of address of the mobile node, the packets between both are forwarded to the care-of address of the mobile node directly without passing through the home agent. This is allowed only when the CN can believe that the home address and the care-of address of the mobile node in the BU message are owned by the same mobile node. To do this, Non-Patent Document 1 shows an RR (Return Routability) procedure for making sure that the home address and the care-of address of the mobile node in the BU message are owned by the same mobile node.

In this RR procedure, the mobile node needs to acquire securely generated two tokens from the CN before sending the BU message to the CN. Prior to starting the RR procedure, the mobile node first sends a Home Test Init (HoTi) message and a Care-of Test Init (CoTi) message to the CN. The HoTi message is sent via the home agent using the home address of the mobile node as a packet source address, and the CoTi message is directly sent using the care-of address of the mobile node as the packet source address. Upon receipt of the HoTi message, the CN responds with a Home Test (HoT) message. The HoT message is sent to the home address of the mobile node, including a security token, called a home keygen token (HoK), encrypted using a secret key based on the home address of the mobile node. Further, upon receipt of the CoTi message, the CN responds with a Care-of Test (CoT) message. The CoT message is sent to the care-of address of the mobile node, including a security token, called a care-of keygen token (CoK), encrypted using a secret key based on the care-of address of the mobile node.

Upon receipt of both the HoT message and the CoT message, the mobile node can send the CN a BU message including an authenticator to allow the CN to authenticate the mobile node. This authenticator is a checksum of the BU message encrypted using a key in which HoK is linked to CoK. According to this method, upon receipt of the BU message, the CN calculates a checksum separately from the checksum in the BU message, and checks whether the calculated checksum is identical to the received authenticator so that it will be able to give proof that the home address and the care-of address of the mobile node in the BU message surely indicate the same location.

The standard RR procedure enables the CN to prove the reachability of the home address of the mobile node via the care-of address, but it still leaves room for improvement. Especially suppose that the number of messages increases. Given that the mobile node has two or more interfaces and two or more care-of addresses as shown in Non-Patent Document 2 and Non-Patent Document 3 cited below, two messages (CoTi message and CoT message) about each care-of address need to be exchanged in order to establish reachability and validity.

Patent Documents 1, 2, and 3 propose methods using an encrypted address for a BU message as other methods of proving the reachability and validity of the care-of address. However, since these methods limit the number of available bits in IPv6, there is still a question as to the level of security of the encrypted address. Particularly, Patent Document 2 discloses that secure router advertisements are included in a BU message so that the CN will derive the validity of addresses from prefixes in these router advertisements. However, since this method requires a proof system that provides coverage as broad as the Internet, it is not easy to implement this method at present. Patent Document 3 proposes that the mobile node and the CN exchange a public key and a private key to build a confidential relationship. This method, however, cannot prevent a malicious mobile node from establishing a confidential relationship with the CN to attack the CN with the care-of address. To prevent this, a mechanism similar to the standard RR procedure must be employed.

Thus, the standard MIPv6 (Non-Patent Document 1) as a conventional technique discloses the RR (Return Routability) procedure as means to allow a CN to authenticate an MN upon route optimization. The RR in MIPv6 consists of a HoA test for protection from unauthorized redirection and a CoA test for confirmation of reachability.

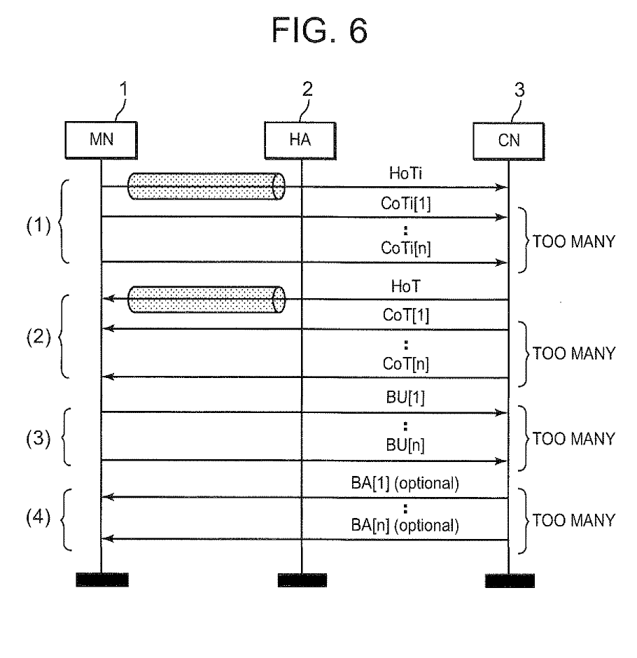

On the other hand, Monami6 (Mobile Nodes and Multiple Interfaces in IPv6) includes various suggestions for dealing with a case where a mobile node (MN) has two or more interfaces. The MN using a mobile IP (Internet Protocol) registers a care-of address (CoA) as a destination address with a home agent (HA) that manages the MN's home address (HoA) and requests forwarding of packets destined to the HoA. If the MN can register two or more CoAs in association with one HoA at the same time, the MN having the two or more interfaces can register CoAs assigned to respective interfaces to enable instantaneous switching to a CoA to be used depending on the interface state. FIG. 6 is an illustration showing a conventional bulk BU (binding update) in Monami6. Non-Patent Document 2 describes a technique (Bulk mCoA BU) for sending one BU for two or more CoAs at a time in one go when an MN 1 registers the two or more CoAs with an HA 2 in association with one HoA as shown in FIG. 6. However, there is no mention in Monami6 about means to perform route optimization (RO) (i.e., to register two or more CoAs for CN).

Non-Patent Document 1: Johnson, D. B., Perkins, C. E., and Arkko, J., “Mobility Support in IPv6,” Internet Engineering Task Force Request For Comments 3775, June 2004.

Non-Patent Document 2: Wakikawa, R., et al., “Multiple Care-of Addresses Registration,” Internet Draft: draft-wakikawa-mobileip-multiplecoa-03.txt, 19 Jun. 2004.

Non-Patent Document 3: Wakikawa, R., et al., “Multiple Care-of Addresses Registration,” Internet Draft: draft-ietf-monami6-multiplecoa-00.txt, 12 Jun. 2006.

Patent Document 1: Kempf, J., et al., US Patent Application Publication 2003/0211842A1 entitled “Securing Binding Update Using Address Based Keys,” 13 Nov. 2003.

Patent Document 2: Aura, A. T., US Patent Application Publication 2005/0041634A1 entitled “Verifying Location of a Mobile Node,” 24 Feb. 2005.

Patent Document 3: Haddad, W., US Patent Application Publication 2006/0227971A1 entitled “Secret Authentication Key Setup in Mobile IPv6,” 12 Oct. 2006.

It is considered that Monami6, which allows an MN to register two or more CoAs with an HA as a bulk BU (binding update), is simply combined with the MIPv6 RR procedure for allowing a CN to authenticate the MN, and in the combined RR procedure, the MN performs the bulk BU on binding messages associated with two or more CoAs collectively for the CN (here, which is used to register the two or more CoAs for the CN). However, Bulk mCoA BU in Monami6 as shown in FIG. 5 has no idea to authenticate the bulk BU in terms of IPsec to protect security between the MN 1 and the HA 2. On the other hand, in the MIPv6 RR procedure that aims at allowing a CN 3 to authenticate the MN 1, it cannot make such an assumption that IPSec provides secure protection between the MN 1 and the CN 3. In this case, since the contents of BU messages differ, BU messages in the RR procedure require a binding management key (Kbm) or a signature (MAC) for each individual CoA (as will be described later). Thus, since the bulk BU destined to the HA in Monami6 cannot be applied to the RR procedure between the MN 1 and the CN 3, BU messages in the RR procedure between the MN 1 and the CN 3 need to be sent to the CN on a CoA basis.

FIG. 6 shows the operation in this case, i.e., a problem to be solved by the present invention. The following describes the MIPv6 RR procedure with reference to this drawing.

(1) The MN 1 generates a cookie for each of HoA and CoA, encapsulates HoTI (Home-Test-Init) messages destined to the CN 3 as those to be destined to the HA 2, and sends them via a home network 4 and a foreign network 5a while directly sending the CN 3 each of CoTi (Care-of-Test-Init) [1]-[n] messages about each of two or more (n) CoAs [1] to [n] directly destined to the CN 3 individually via foreign networks 5a and 5b without passing through the HA 2 in order to send the HoA and the cookie of each CoA to the CN 3.

(2) In response to this, the CN 3 generates a signature token for each of the HoA and CoAs [1]-[n] from each cookie or the like, and sends a HoT (Home-Test) message destined to the MN 1 via the HA 2 while sending the CoT (Care-of-Test) [1]-[n] messages about the CoAs [1] to [n] directly destined to the MN 1 in order to send the signature tokens.

(3) Then, in response to this, the MN 1 generates a binding management key Kbm [1]-[n] for each of CoAs [1] to [n] from each signature token or the like, generates each message authentication code MAC [1]-[n], and individually sends a binding update message BU[1]-[n] about each CoA[1]-[n] directly destined to the CN 3 to send Kbm [1]-[n] and MAC [1]-[n]. The CN 3 generates MAC [1]-[n] separately from or in the same manner as the MN 1 to authenticate BU [1]-[n] messages.

(4) As an option, the CN 3 may send binding confirmation messages BA [1] to [n] in response to the BU [1]-[n] messages. In other words, in order to use the MIPv6 RR procedure to register two or more CoAs, not only a simple difference as to whether the destination of each BU message is the HA or the CN, but also a difference related to two or more procedures resulting from the security relationship with the MN must be considered. Thus, since each of CoTi, CoT, and BU messages are sent to each of the two or more CoAs through the processes (1)-(3), there is a problem that a considerable number (3n) of messages need sending.

### DISCLOSURE OF THE INVENTION

In view of the above problem, it is an object of the present invention to provide a communication method, a communication system, a mobile node, and a communication node, capable of reducing the number of messages handled in an Return Routability (RR) procedure for performing authentication between a mobile node (MN) and a peer communication node (CN: Correspondent Node).

In order to attain the above object, the present invention provides a communication method in which a peer communication node authenticates a mobile node having one or more interfaces with a care-of address assigned to each of the one or more interfaces, the method comprising:

a step where the mobile node pairs two or more care-of addresses assigned respectively to the one or more interfaces, and sends the peer communication node one or more first messages including a second care-of address by setting a first care-of address in each pair of care-of addresses as a source address;

a step where the peer communication node receives the one or more first messages, generates signature tokens for the first and second care-of addresses, and sends one or more second messages including the generated signature tokens to the second care-of address of the mobile node;

a step where the mobile node generates one or more authentication codes for the two or more care-of addresses using each signature token in the one or more second messages, and sends the peer communication node the two or more care-of addresses and the one or more authentication codes through one or more binding update messages; and

a step where the peer communication node authenticates the one or more authentication codes for the two or more care-of addresses in the one or more binding update messages.

In order to attain the above object, the present invention also provide a communication system in which a peer communication node authenticates a mobile node having one or more interfaces with a care-of address assigned to each of the one or more interfaces, the system comprising:

means for causing the mobile node to pair two or more care-of addresses assigned respectively to the one or more interfaces, and send the peer communication node one or more first messages including a second care-of address by setting a first care-of address in each pair of care-of addresses as a source address;

means for causing the peer communication node to receive the one or more first messages, generate signature tokens for the first and second care-of addresses, and send one or more second messages including the generated signature tokens to the second care-of address of the mobile node;

means for causing the mobile node to generate one or more authentication codes for the two or more care-of addresses using each signature token in the one or more second messages, and send the peer communication node the two or more care-of addresses and the one or more authentication codes through one or more binding update messages; and

means for causing the peer communication node to authenticate the one or more authentication codes for the two or more care-of addresses in the one or more binding update messages.

In order to attain the above object, the present invention further provides a mobile node having one or more interfaces with a care-of address assigned to each of the one or more interfaces in a communication system in which a peer communication node authenticates the mobile node, the mobile node comprising:

means for pairing two or more care-of addresses assigned respectively to the one or more interfaces, and sending the peer communication node one or more first messages including a second care-of address by setting a first care-of address in each pair of care-of addresses as a source address; and

means for, when receiving, at the second care-of address from the peer communication node, one or more second messages including signature tokens for the first and second care-of addresses generated based on the one or more first messages, generating one or more authentication codes for the two or more care-of addresses using each signature token in the one or more second messages, and sending the peer communication node the two or more care-of addresses and the common authentication code through one or more binding update messages.

Further, in order to attain the above object, the present invention provides a peer communication node in a communication system in which the peer communication node authenticates a mobile node having one or more interfaces with a care-of address assigned to each of the one or more interfaces, the peer communication node comprising:

means for receiving one or more first messages sent from the mobile node after the mobile node pairs two or more care-of addresses assigned respectively to the one or more interfaces, setting a first care-of address in each pair of care-of addresses as a source address, and including a second care-of address in the one of more first messages;

means for generating signature tokens for the first and second care-of addresses based on the one or more first messages received, and sending one or more second messages including the generated signature tokens to the second care-of address of the mobile node;

means for receiving one or more binding update messages sent from the mobile node after the mobile node generates one or more authentication codes for the two or more care-of addresses using each signature token in the one or more second messages, and including the two or more care-of addresses and the one or more authentication codes in the one or more binding update messages; and

means for authenticating the one or more authentication codes for the two or more care-of addresses in the one or more binding update messages received.

This structure can reduce the number of messages handled in a Return Routability (RR) procedure for performing authentication between a mobile node (MN) and a peer communication node (CN).

According to the present invention, the number of messages handled in a Return Routability (RR) procedure for performing authentication between a mobile node (MN) and a peer communication node (ON) can be reduced.

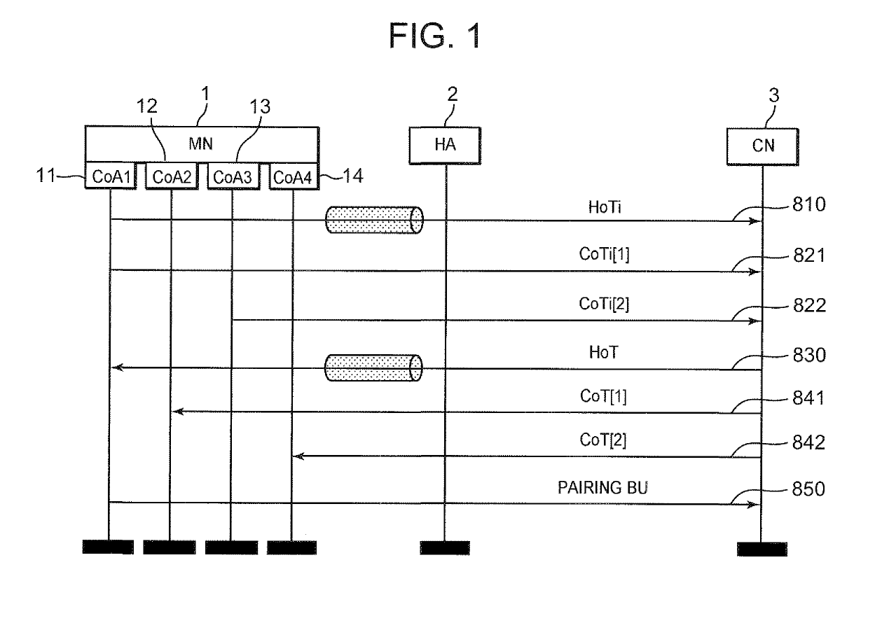

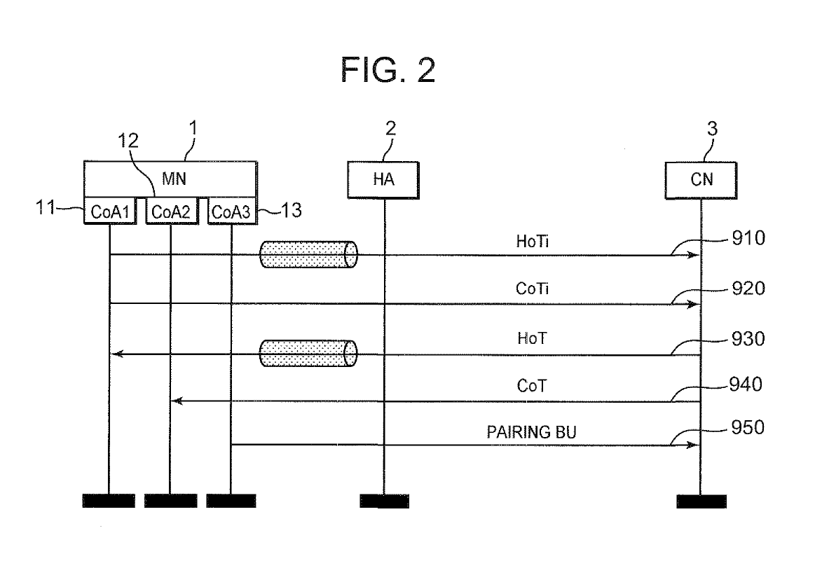

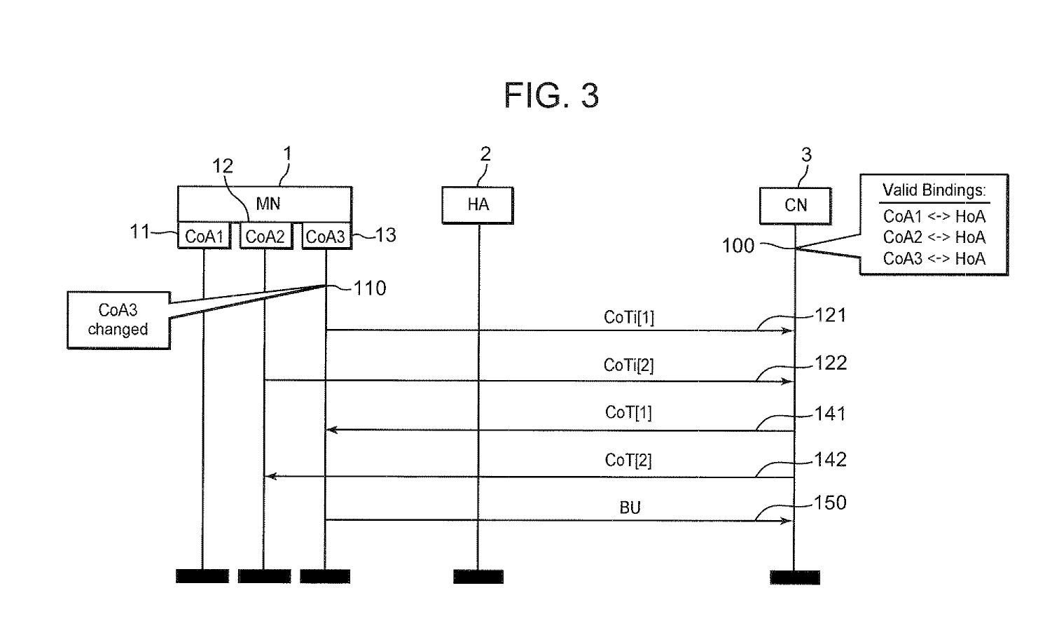

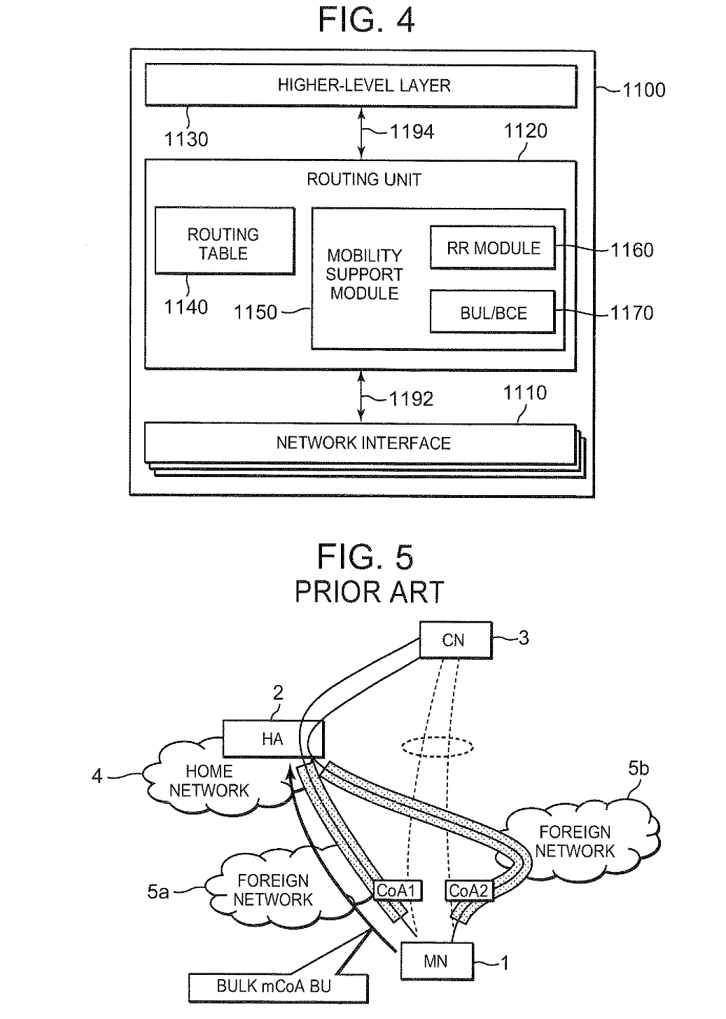

### BRIEF DESCRIPTION OF THE DRAWINGS

[FIG. 1] It is an illustration showing a communication sequence in one preferred embodiment of the present invention.

[FIG. 2] It is an illustration showing another communication sequence in the embodiment of the present invention.

[FIG. 3] It is an illustration showing still another communication sequence in the embodiment of the present invention.

[FIG. 4] It is a block diagram showing a functional configuration of a mobile node and a communication partner in FIG. 1, FIG. 2, and FIG. 3.

[FIG. 5] It is an illustration showing a bulk BU in conventional Monami6.

[FIG. 6] It is an illustration showing the problem to be solved by the present invention.

### BEST MODE FOR CARRYING OUT THE INVENTION

A preferred embodiment of the present invention will now be described with reference to the accompanying drawings.

<Pairing of Plural CoAs>

In this embodiment, it is assumed that a mobile node and a CN are both located in a network configuration with a highly confidential relationship, and when the CN receives a packet with a specific source address, the specific source address really exists (i.e., it is reachable) and the packet has actually come from the specific source address. This is to assure packet forwarding in a normal network, where packets destined to a real source address are forwarded and packets destined to an unreal source address are discarded. Such a network with a highly confidential relationship can be implemented in numerous ways. For example, each router in the network performs ingress filtering so that when a packet with a source address, which should not be received via an interface, is intercepted on the interface, the router discards the packet. Thus, the network configuration constructed with the router can assure that the forwarded packet source address exists and is valid. Examples of this network configuration with a highly confidential relationship include a cellular operator and a third-generation all-IP network employed in WLAN (wireless LAN) related to the cellular operator.

In this type of network, if one CoTi message and one CoT message are used to prove the reachability and validity of one care-of address, the number of messages will be too many. This is because if the reachability (forwarding assurance) is guaranteed, the validity of the address (the validity of the source address) will also be guaranteed. Therefore, in the embodiment, multiple care-of addresses are divided into pairs of care-of addresses (pairing) so that when a CoTi message is sent from a first care-of address, a CoT message corresponding to the CoTi message is sent to a second care-of address different from the first care-of address.

FIG. 1 shows a communication sequence in the embodiment. For the sake of simplification, it is assumed that an MN 1 has four interfaces 11, 12, 13, and 14, and CoA 1, CoA 2, CoA 3, and CoA 4 as care-of addresses are assigned to the interfaces 11, 12, 13, and 14, respectively. As will be understood by those skilled in the art, it can be applied to much more care-of addresses.

(1) CoTi (HoTi)

In FIG. 1, according to the standard RR procedure, the MN 1 first sends a CN 3 an HoTi message 810, a CoTi[1] message 821 with CoA 1 and CoA 2 paired, and a CoTi[2] message 822 with CoA 3 and CoA 4 paired. The HoTi message 810 is tunneled to an HA 2 as the home agent of the MN 1, and further forwarded to the CN 3.

(2) CoT (HoT)

Next, according to the standard RR procedure, the CN 3 responds to the HoTi message 810 with a HoT message 830. The source address of the CoTi[1] message 821 is the CoA 1 of the MN 1. Here, in a normal RR procedure, upon receipt of the CoTi[1] message 821, the CN 3 generates a CoK as a signature token corresponding to the CoA 1 and sends a CoT message to the CoA 1. On the other hand, in this embodiment, the MN 1 uses a mobility header option to describe the CoA 2 in the CoTi[1] message 821. Therefore, the CN 3 generates a CoK corresponding to both of the CoA 1 and the CoA 2, and sends a CoT[1] message 841 to the CoA 2 in place of the CoA 1. Similarly, the source address of the CoTi[2] message 822 is the CoA 3 of the MN 1, and the MN 1 uses the mobility header option to describe the CoA 4 in the CoTi[2] message 822. Therefore, the CN 3 generates a CoK corresponding to both of the CoA 3 and the CoA 4, and sends a CoT[2] message 842 to the CoA 4.

(3) Pairing BU

The present invention uses the idea of a pairing BU for sending BU messages all at once upon sending the BU messages to register two CoAs with the CN efficiently. This seems similar to the bulk BU to the CN in terms of registering multiple CoAs all at once, but the way of handling key information as a result of pairing and the method of generating authentication information need to be changed in a manner to be described later. In this specification, an example of a bulk BU in which when there are multiple pairs, pairing BUs are further put together into the bulk BU will also be described as a more preferred implementation method. Note that individual BU messages can be used instead of the pairing BU and the bulk BU for pairing BUs.

The MN 1 gathers the HoT message 830, the CoT[1] message 841, and the CoT[2] message 842 together, and sends a pairing BU message 850 to the CN 3 to register CoAs with the CN. The pairing BU message 850 includes a binding ID suboption as a mobility header suboption to perform multiple CoA registration of all the CoA 1, the CoA 2, the CoA 3, and the CoA 4 with the CN 3. An authenticator in the pairing BU message 850 is generated based on parameters derived from the CoT[1] message 841, the CoT[2] message 842, and the HoT message 830 in a manner to be described below.

The following illustrates the details of parameters included in the messages in FIG. 1.

<HoTi>

The HoTi message 810 includes the following parameters,
Source Address: Home Address of MN 1
Destination Address: Address of CN 3
Mobility Header
   Home Init Cookie

The home init cookie is a value generated by the MN 1 to ensure that a HoT message is sent from a valid CN in response to an HoTi message.

<HoT>

The HoT message 830 sent from the CN 3 in response to the HoTi message 810 includes the following parameters.
Source Address: Address of CN 3
Destination Address: Home Address of MN 1
Mobility Header
   Home Init Cookie
   Home Keygen Token (HoK)
   Home Nonce Index

The home init cookie is the same value as that in the HoTi message 810. The HoK is generated in a form encrypted based on a secret home nonce index known to only the home address of the MN 1 (HoA) and the CN 3. The HoK is the first 64 bits of the following hash value:

HMAC_SHA1(Kcn, (HoA|nonce|0)),

where HMAC_SHA1(Kcn, m) represents a function of message authentication code (MAC) calculated using message m and secret key Kcn in SHA1 hash algorithm, 0 indicates that the value expressed by 8 bits is 0, | represents a concatenation.

The home nonce index is used by the CN 3 to determine whether to match a secret nonce value used to generate the HoK. For example, the CN 3 has an array of 64 different nonce values, and determines whether Nonce Index=0 matches the first nonce value of the nonce value array, whether Nonce Index=1 matches the second nonce value of the nonce value array, etc.

<CoTi[1]>

The CoTi[1] message 821 includes the following parameters.
Source Address: CoA 1
Destination Address: Address of CN 3
Mobility Header
   Care-of Init Cookie [1]
   Additional CoA 2

<CoTi[2]>

The CoTi[2] message 822 includes the following parameters.
Source Address: CoA 3
Destination Address: Address of CN 3
Mobility Header
   Care-of Init Cookie [2]
   Additional CoA 4

The care-of init cookie is a value generated by the MN 1 to ensure that the CoT messages 841 and 842 respectively corresponding to the CoTi[1] message 821 and the CoTi[2] message 822 are sent from the valid CN 3. The “additional CoA 2 and CoA 4” in the CoTi[1] message 821 and the CoTi[2] message 822 are CoAs added respectively in this embodiment.

The CoT[1] message 841 sent by the CN 3 in response to the CoTi[1] message 821 includes the following parameters.
Source Address: Address of CN 3
Destination Address: CoA 2
Mobility Header
   Care-of Init Cookie [1]
   Care-of Keygen Token (Cok) [1]
   Care-of Nonce Index [1]

Similarly, the CoT[2] message 842 sent by the CN 3 in response to the CoTi[2] message 822 includes the following parameters.
Source Address: Address of CN 3
Destination Address: CoA 4
Mobility Header
   Care-of Init Cookie [2]
   Care-of Keygen Token (Cok) [2]
   Care-of Nonce Index [2]

The care-of init cookies [1] and [2] are the same as those in the corresponding CoTi[1] message 821 and the CoTi[2] message 822. The Cok [1] and the Cok [2] are generated in a form encrypted based on secret nonce values known to only both of the care-of addresses (CoA 1, CoA 2) and (CoA 3, CoA 4) of the MN 1 and the CN 3, respectively. The Cok [1] is the first 64 bits of the following hash value:

HMAC_SHA1(Kcn, (CoA1|CoA2|nonce|1)).

Further, the Cok [2] is the first 64 bits of the following hash value:

HMAC_SHA1(Kcn, (CoA3|CoA4|nonce|1)).

Note that “1” is just to distinguish the Cok [1] and the Cok [2] from the HoK, and the value expressed by 8 bits is 1. Here, as will be understood by those skilled in the art, “1” may be another value, e.g., “2,” expressed by another 8 bits to distinguish the Cok [1] and the Cok [2] from a normal Cok generated in the standard RR procedure. The care-of nonce indexes [1] and [2] are used by the CN 3 to determine secret nonces used to generate the Cok [1] and the Cok [2], respectively.

<Pairing BU>

The pairing BU message 850 includes the following parameters.
Source Address: CoA 1
Destination Address: Address of CN 3
Home Address Destination Option
   Home Address of MN 1
Mobility Header
   Sequence Number
   Home Nonce Index
   Care-of Nonce Index [1]
   Binding Unique Identifier Suboption of CoA 1, CoA 2
   Care-of Nonce Index [2]
   Binding Unique Identifier Suboption of CoA 3, CoA 4
   Authenticator

The home nonce index and the care-of nonce indexes [1] and [2] are the same as the values in the HoT message 830, the CoT[1] message 841, and the CoT[2] message 842 to notify the CN 3 which nonce value is used to generate the HoK, the Cok[1], or the Cok[2], respectively. The binding unique identifier suboptions include the CoA 1 and the CoA 2, and the CoA 3 and the CoA 4, respectively, as unique binding identifiers. The authenticator is generated in a form encrypted based on the HoK, the Cok[1], and the Cok[2] in the HoT message 830, the CoT[1] message 841, and the CoT[2] message 842, and the mobility header itself. Here, since the CN 3 knows the home address, the CoA 1, the CoA 2, the CoA 3, the CoA 4, the home nonce index, and the care-of nonce indexes [1] and [2], the CN 3 can recreate the HoK, the Cok [1], and the Cok [2].

The authenticator is an authenticator common to all the CoA 1, the CoA 2, the CoA 3,and the CoA 4, which corresponds to the first 64 bits of the following hash value:

HMAC_SHA1(Kbm, (CoA1|CoA2|CoA3|CoA4|CN address|MH)),

where Kbm represents a binding management key generated from the hash values of the HoK, the Cok[1], and the Cok[2], which is expressed as:

Kbm=SHA1(HoK|Cok[1]|Cok[2]).

The CN address represents the address of the CN 3, MH represents a mobility header reset to 0 according to the authenticator value.

The authenticator value can be generated and proved independently by the CN 3 using information in the pairing BU message 850. Here, it should be noted that it is preferred to arrange, in the pairing BU message 850, the care-of nonce indexes [1] and [2], and the binding unique identifier suboptions of the CoA 1 and the CoA 2, and the CoA 3 and the CoA in a manner to group the CoA 1, the CoA 2, the CoA 3, and the CoA 4 with corresponding nonces. It is also preferred that the four CoA 1, CoA 2, CoA 3, and CoA 4 be derived upon generation of the authenticator in order of the binding unique identifier suboption.

Here, it will be apparent to those skilled in the art that any one of the four CoA 1, CoA 2, CoA 3, and CoA 4 may be used as the source address of the pairing BU message 850. Further, in the above description, one CoK is used for each pair (CoA 1, CoA 2) or (CoA 3, CoA 4), which has the advantage of being able to reduce the bandwidth and processing time necessary for the MN 1 and the CN 3. However, when one of the pairs (CoA 1, CoA 2) and (CoA 3, CoA 4) is changed, since the CoK is also changed, both CoAs need registering. For example, when the CoA 2 and the CoA 3 are changed due to handover between the interfaces 12 and 13, the MN 1 has to resend both the CoTi[1] message 821 and the CoTi[2] message 822 to acquire new Coks for the CoA 1 and the CoA 4 even if there is no change in CoA 1 and CoA 4.

<<One CoK for One CoA>>

The CN 3 can generate one CoK for one CoA and arrange it in the same CoT message. In this case, the content of the CoT[1] message 841 is changed as follows.
Source Address: Address of CN 3
Destination Address: CoA 2
Mobility Header
   Care-of Init Cookie [1]
   Care-of Keygen Token (Cok) [1a]
   Care-of Keygen Token (Cok) [1b]
   Care-of Nonce Index [1]

The Cok [1a] is generated using the CoA 1 (=the source address of the CoTi[1] message 821), and the Cok [1b] is generated using the CoA 2 (=the destination address of the CoT[1] message 841). In other words, the Cok [1a] is the first 64 bits of the following hash value:

HMAC_SHA1(Kcn,(CoA1|nonce|1)), and

the Cok [1b] is the first 64 bits of the following hash value:

HMAC_SHA1(Kcn,(CoA2|nonce|1)).

In this example, the two Cok [1a] and Cok [1b] use the same care-of nonce, and the MN 1 arranges the Cok [1a] for the CoA 1 and the Cok [1b] for the CoA 2 in order of appearance.

Thus, since an independent Cok is used for each CoA, the MN 1 can respond flexibly upon the next registration. For example, suppose that the CoA 2 and the CoA 3 are changed due to handover between the interfaces 12 and 13 as mentioned above. In this case, the MN 1 has only to pair the CoA 2 and the CoA 3 again and send only one CoTi message. This CoTi message is sent from the new CoA 2, describing the CoA 3 as an additional CoA. In response to this, the CN 3 sends, to the CoA 3, a CoT message including a Cok for the CoA 2 and a Cok for the CoA 3. It can be said that this method is more appropriate for registration using individual BU messages instead of the pairing BU.

<<One Care-of Nonce for One CoA>>

It will be apparent to those skilled in the art that other modifications are possible. For example, in order to increase the encrypting power, the CN 3 may select different care-of nonces for individual CoAs in one CoT message. In this case, the content of the CoT[1] message 841 is changed as follows.
Source Address: Address of CN 3
Destination Address: CoA 2
Mobility Header
   Care-of Init Cookie [1]
   Care-of Keygen Token (Cok) [1a]
   Care-of Keygen Token (Cok) [1b]
   Care-of Nonce Index [1a]
   Care-of Nonce Index [1b]
      The MN 1 arranges, in order of appearance, the Cok [1a] and the care-of nonce index [1a] for the CoA 1 and the Cok [1b] and the care-of nonce index [1b] for the CoA 2.

<<Deriving First CoA from Memory>>

In the above description, the CoT messages 841 and 842 include one or two care-of keygen tokens for two CoAs. Here, as a modification, only one CoA is described in the CoT messages 841 and 842. It is preferred that the MN 1 should store paired two CoAs so that it can derive the other CoA that is not described in the CoT messages 841 and 842. For example, when sending the CoTi[1] message 821, the MN 1 can store, in the memory, the CoA 1, the CoA 2, and the care-of init cookie [1]. Therefore, when receiving the CoT[1] message 841, the MN 1 can reference the memory based on the care-of init cookie [1]in the CoT[1] message 841 to know both the CoA 1 and the CoA 2 associated with the CoT[1] message 841 even if only the CoA 2 is described in the CoT[1] message 841.

<<Deriving First CoA from Care-of Init Cookie>>

However, the method of storing the CoA 1, the CoA 2, and the care-of init cookie [1] in the memory has the disadvantage that the MN 1 is required to have a high memory capacity to maintain state information related to the RR procedure. Therefore, as a modification, the CoA 1 and the CoA 2 are embedded in the care-of init cookie [1] using a hash function or the like. According to this method, the MN 1 can derive the CoA 1 and the CoA 2 without referencing the CoA 1 and the CoA 2 stored in an area different from the care-of init cookie [1].

<<Describing First CoA in CoT>>

Another method desirable for the CN 3 is to describe the other CoA in the CoT messages 841 and 842. The content of the CoT[1] message 841 in this method is changed as follows.
Source Address; Address of CN 3
Destination Address: CoA 2
Mobility Header
   Care-of Init Cookie [1]
   Care-of Keygen Token (Cok) [1b]
   Care-of Nonce Index [1b]
   Additional CoA: CoA 2
   Care-of Keygen Token (Cok) [1a]
   Care-of Nonce Index [1a]

According to this method, the MN 1 can specially approach to both CoAs or derive both CoAs without storing them in the memory. However, the MN 1 needs to store, in the memory, such a state that the care-of init cookie is recorded together with the CoAs and the address of the CN 3. This method enables the MN 1 to check the validity of the received CoT message and avoid the security risk of being exposed to an attacker who has sent a false CoT message to the MN 1.

<<Odd Number of CoAs>>

In the above description, different CoAs are used for the CoTi message and the CoT message to reduce the number of messages necessary for BU registration.

In other words, in the above description, two CoAs are paired upon exchanging the CoTi message and the CoT message. Therefore, if the number of CoAs is odd, one CoA is left without being paired. One method of dealing with this state is to pair the odd CoA with a previously used CoA. Another method is to use the standard RR procedure for the last one CoA to set the last one CoA as the source address of the CoTi message and the destination address of the CoT message.

Still another method is to group the odd CoA into another pair of CoAs. In this method, a pairing BU message is basically used to prove the validity and reachability of the odd CoA. A sequence in this method is shown in FIG. 2. For the sake of simplification, it is assumed in FIG. 2 that the MN 1 has three CoA 1, CoA 2, and CoA 3 assigned to interfaces 11, 12, and 13, respectively. It is apparent to those skilled in the art that if another odd CoA is to be handled, this state can be dealt with by combining it with the above-mentioned paring method.

First, according to the standard RR procedure, the MN 1 sends a HoTi message 910 and a CoTi message 920 to the CN 3. The HoTi message 910 is tunneled and sent to the HA 2 as the home agent of the MN 1, and further forwarded to the CN 3. The CN 3 responds to the HoTi message 910 with a HoT message 930 according to the standard RR procedure. The source address of the CoTi message 920 is the CoA 1 of the MN 1. Here, in a normal RR procedure, upon receipt of the CoTi message 920, the CN 3 generates a CoK corresponding to the CoA 1 and sends a CoT message to the CoA 1, while in the embodiment, the MN 1 instructs the CoA 2 and the CoA 3 by means of an additional mobility header option in the HoTi message 910. Therefore, when receiving the CoTi message 920, the CN 3 generates a CoK corresponding to the CoA 1, the CoA 2, and the CoA 3, and sends a CoT message 940 to the CoA 2.

The MN 1 gathers the HoT message 930 and the CoT message 940 and sends a pairing BU message 950 to the CN 3 to complete registration. In order that the CN 3 proves the reachability and validity of the CoA 3, the pairing BU message 950 is sent by setting the CoA 3 as the source address. Here, as discussed above as a premise, since a packet whose source address is the CoA 3 has been received, this procedure is used in a highly trusted network, which means that the CoA 3 is valid and reachable. The pairing BU message 950 includes a mobility header suboption (e.g., binding unique identifier suboption) to complete the registration of multiple CoA, i.e., CoA 1, CoA 2, and CoA 3, with the CN. The value of the authenticator in the pairing BU message 950 is generated based on parameters derived from the HoT message 930 and the CoT message 940.

Here, those skilled in the art will readily appreciate that the CoK and the authenticator can be calculated by a method in which the third CoA 3 is added to the above-mentioned method. Likewise, a modification using an independent Cok for each CoA and an independent care-of nonce for each CoA can be applied. Further, a CoTi message including the CoA 1 and the CoA 3 may be sent to send a CoT message to the CoA 2. Since this is obvious to those skilled in the art, the detailed description thereof will be omitted.

<<Send CoA and Receive CoA>>

The embodiment shown in FIG. 1 and FIG. 2 illustrates the application to a highly trusted network, but it can also be applied to other networks. As an example, there is a case where the MN uses two or more different CoAs for different purposes during communication with the CN. It can be assumed that a set of multiple CoAs is used for uplink (send) traffic and another set of multiple CoAs is used for downlink (receive) traffic for the purpose of load balancing, for example. It this example of assumption, one set of multiple CoAs is used only for packet transmission from the MN to the CN and the other set of multiple CoAs is used only for packet transmission from the CN to the MN. In this case, the reachability and validity of each CoA do not need to be proved using the standard RR procedure.

Thus, since the MN uses one set of multiple CoAs only for transmission, only the validity of these multiple CoAs (hereinafter referred to as “uplink CoAs”) has only to be tested without the need to test the reachability thereof. Similarly, since the MN uses the other set of multiple CoAs only for reception, only the reachability of these multiple CoAs (hereinafter referred to as “downlink CoAs”) has only to be tested without the need to test the validity thereof. Note that the MN may confirm with the CN through a confirmation message which CoA is set as the uplink or downlink CoA.

In this case, the above method used in the highly trusted network can also be applied. An example will be described with reference to the sequence chart shown in FIG. 1. Suppose here that the CoA 1 and the CoA 3 are uplink CoAs and the CoA 2 and the CoA 4 are downlink CoAs. It is apparent to those skilled in the art that the RR procedure shown in FIG. 1 can be used. Since the CoA 1 and the CoA 3 are sent through the CoTi messages 821 and 822 with the CoA 1 and CoA 3 set as the source addresses, respectively, the validity thereof is tested. Here, the MN 1 describes the downlink CoA 2 in the CoTi[1] message 821 and the downlink CoA 4 in the CoTi[2] message 822. Therefore, the CoT[1] message 841 is sent to the CoA 2 and the reachability of the CoA 2 is tested. On the other hand, the CoT[2] message 842 is sent to the CoA 4 and the reachability of the CoA 4 is tested. Finally, the pairing BU message 850 is sent to complete the registration of multiple CoAs, i.e., CoA 1 to CoA 4, with the CN. Of course, the pairing BU message 850 is sent by setting the uplink CoA as the source address.

As a method of dealing with a case where any malicious (or malfunctioning) node (including a mobile node) tries to use an uplink CoA for downlink traffic or a downlink CoA for uplink traffic, it is desired that the MN 1 should clearly specify, in the pairing BU message 850, which CoA is an uplink CoA and which CoA is a downlink CoA. This can be done by using a flag in the binding unique identifier suboption for each CoA. As a result, the CN 3 that has received the pairing BU message 850 can easily make a distinction between the uplink CoA and the downlink CoA upon managing them distinctly. If the usage of a CoA in the BU message is inconsistent with the test result, the CN 3 can refuse registration. Even after registration, if the actual usage is inconsistent, the CN 3 can refuse actual communication or notify that CoA usage is inconsistent. As another method, the CN 3 may add information or record CoA usage upon transmission of a test message so that it can identify whether a CoA to be received later through a BU message is the uplink CoA or downlink CoA. In other words, it is desired to enable the CN 3 to confirm that a CoA (its usage=content whose safe use is guaranteed) checked upon sending and receiving the CoTi message and the CoT message is consistent with the application of the CoA from the mobile node 1 through a BU or the actual usage thereof.

As a further countermeasure, the CN 3 uses a particular order to generate a CoK for each pair of uplink CoA and downlink CoA. Suppose that the CoA 1 is the uplink CoA and the CoA 2. In this case, when the CN 3 generates a CoK to be included in the CoT[1] message 841, this CoK is generated as the first 64 bits of the following hash value:

HMAC_SHA1(Kcn, (CoA1|CoA2|nonce|1)).

In other words, the uplink CoA 1 is always located before the downlink CoA 2.

When generating a different CoK for each CoA, the CN 3 uses different 8 bits in a hash calculation. In this case, the CoK for the uplink CoA 1 is generated as the first 64 bits of the following hash value:

HMAC_SHA1(Kcn, (CoA1|nonce|3)).

On the other hand, the Cok for the downlink CoA 2 is generated as the first 64 bits of the following hash value:

HMAC_SHA1(Kcn, (CoA2|nonce|4)).

Here, the 8-bit values “3” and “4” are used to distinguish the uplink CoA 1 from the downlink CoA 2. It is apparent to those skilled in the art that they may be other 8-bit values as long as the CoK for the uplink CoA can be distinguished from the CoK for the downlink CoA.

As a further countermeasure, the CN 3 may use different nonce values for the uplink CoA and the downlink CoA. For example, in the case of a particular nonce index=1, a different nonce index is used depending on whether the CoA is the uplink CoA, downlink CoA, or a normal CoA. Here, in the case of the normal CoA, both the reachability and the validity thereof are tested according to the standard RR procedure.

<<Loss of CoT>>

In the above embodiment, the pairing BU message 850 assumes that all the CoAs are to be registered (bulk BU), but those skilled in the art can appreciate that they are not indispensable. For example, when a CoTi message or CoT message is discarded due to network congestion, the MN 1 does not receive any CoT message. in this case, the MN 1 may choose to continue registration through the pairing BU message 850. As one way to do this, the MN 1 sets up a timer at the first time of starting the RR procedure, and after the timer expires, the MN 1 sends the pairing BU message 850 for CoT messages received until then. A further BU message or pairing BU message 850 can be sent for CoT messages received after that. Of course, the HoT message 830 must be received before transmission of the pairing BU message 850.

As another method, when receiving the HoT message 830 before the timer expires, the MN 1 sends the pairing BU message 850 as soon as possible. This method works well because the exchange of the HoTi message 810 and the HoT message 830, which has to pass through a bi-directional tunnel between the MN 1 and the HA 2, takes a longer time than the exchange of the CoTi messages 821, 822 and the CoT message 841, 842. Therefore, the MN 1 receives some of the CoT messages 841 and 842 under normal conditions before receiving the HoT message 830, though not all of them. If the MN 1 assigns preferences to multiple CoAs, still another method can be used. In this case, when receiving a CoT message for a more desirable (higher priority) CoA, the MN 1 sends the pairing BU message 850 as soon as possible without waiting for the remaining CoT messages.

When sending the pairing BU message 850 only for a certain CoA, the MN 1 needs to alter the above-mentioned parameters. A desirable method is such that the MN 1 selects CoAs for CoT messages received successfully and includes only the selected CoAs in the pairing BU message 850. Such a procedure to construct parameters such as CoA partially in the pairing BU message 850 is the same as that in the embodiment, and the selected CoAs look as if they were all the CoAs of the MN 1.

The object of the present invention is to reduce the number of messages upon registration of multiple CoAs. The registration of multiple CoAs with the CN 3 takes place in three cases. The first case is when the MN 1 started up for the first time to acquire all the CoA at the same time. At this time, the MN 1 registers multiple CoAs with the CN 3 at the same time. The second case is a more common case where the MN 1 establishes communication with the CN 3 for the first time. At this time, since the CN 3 does not know any CoA of the MN 1, the MN 1 registers multiple CoAs with the CN 3. The third case is when the MN 1 has not moved for a relatively long time and the validity period of all bindings is about to expire. At this time, the MN 1 registers multiple CoAs with the CN 3 to update all the bindings at the same time.

Still another case of registering multiple CoAs with the CN 3 is when the MN 1 has performed handover and hence one or some of CoAs have been changed. Most other CoAs remain unchanged. In such a case, the MN 1 may be required to register, with the CN, multiple CoAs including all the multiple CoAs already registered, but it will have only to perform the RR procedure for new CoAs changed. When performing this type of binding update, if the valid period is unexpired, the MN 1 will not need to reacquire the Hok. However, in the normal RR procedure, since the MN 1 has no means to know whether the previously-acquired Hok is still valid or not, the MN 1 may be required to exchange the HoTi message 810 and the HoT message 830 as usual. It takes time to exchange the HoTi message 810 and the HoT message 830 because of the need to pass through the bi-directional tunnel between the MN 1 and the HA 2. This can increase the potentiality of updating the CN 3 with the latest CoA.

In this embodiment, a further advantage of binding the multiple CoAs to the HoA is to prevent an unnecessary delay caused by the exchange of the HoTi message 810 and the HoT message 830. In other words, a currently existing valid first CoA is used to establish a binding of a new second CoA to this valid first CoA. Namely, assuming that the binding of the first CoA to the HoA currently exists, the binding of the second CoA to the first CoA is taken to means the binding of the second CoA to the HoA.

Referring to FIG. 3, this embodiment will further be described. The MN 1 has the CoA 1, the CoA 2, and the CoA 3 assigned to the interfaces 11, 12, and 13, respectively. It is assumed that the registration of multiple CoAs with the CN 3, i.e., the registration of CoA 1, CoA 2, and CoA 3 with respect to the HoA of the MN 1 has been completed at some point 100, and the CN 3 already has valid bindings. After that, handover occurs on the interface 13 of the MN 1 at point 110 to change the CoA 3. In this case, in order to prevent a delay caused by the exchange of the HoTi message 810 and the HoT message 830 shown in FIG. 1 and FIG. 2, the MN 1 establishes a binding of new CoA 3 using the binding of the currently valid CoA 2 to the HoA instead.

In FIG. 3, the MN 1 sends a CoTi[1] message 121 and a CoTi[2] message 122 by setting the CoA 3, and the CoA 2 as source addresses, respectively. When receiving a corresponding CoT[1] message 141 (including a CoK for the CoA 3) and a CoT[2] message 142 (including a CoK for the CoA 2), respectively, the MN 1 uses the two CoKs to send a special BU message 150 for binding the CoA 3 to the CoA 2. It is preferred that the BU message 150 should include a special signal instructing the CN 3 of the binding of the CoA 3 and the CoA 2, the binding of the CoA 2 and the HoA, and a new binding of the CoA 3 and the HoA.

It will be apparent to those skilled in the art that the same procedure can be used in a case of no handover, e.g., where a new interface is powered on and hence a new CoA is added. It will also be apparent to those skilled in the art that if the MN 1 and the CN 3 exist in a highly trusted network, the exchange of one CoTi/CoT message can be omitted by the above-mentioned procedure. In this case, the CoTi[2] message 122 and the CoT[1] message 141 in FIG. 3 can be omitted. Instead, the CoTi[1] message 121 describes the CoA 2 as an additional CoA, and the CoT[2] message 142 as a response to the CoTi[1] message 121 includes the CoK for the CoA 2 and the CoA 3. The CoK for the CoA 2 and the CoA 3 is used to establish the binding of the CoA 3 and the CoA 2 in the BU message 150 and further the binding of the CoA 3 and the HoA. This method can also be applied to a case where the CoA 3 is used as the uplink CoA only and the CoA 2 is used as the downlink CoA only even if the MN 1 and the CN 3 are not located in the highly trusted network.

Here, it will be apparent to those skilled in the art that the CoTi[2] message 122 and the CoT[2] message 142 in FIG. 3 are not actually the CoTi message and the CoT message, which are the results obtained by sending the HoTi message and the HoT message virtually using route optimization with the binding of the CoA 2 to the HoA. In other words, the CoTi[2] message 122 in FIG. 3 is actually an HoTi message sent at the source address=CoA 2 in a home address destination option, and the CoT[2] message 142 is actually an HoT message sent to the CoA 2 with a routing header including the HoA. It will be apparent to those skilled in the art that the above description is just the preferred embodiment of the present invention, and various modifications are possible without departing from the scope of the invention.

<Number of Interfaces of Terminal>

This specification assumes that the MN 1 has the multiple interfaces 11, 12, 13, and 14, and the interfaces have CoAs, respectively. However, in terms of implementing the content of the invention, it does not matter how many physical interfaces the MN 1 actually has. Further, in the IPv6 specifications, since two or more addresses can be assigned to one interface, such a case that two or more addresses are assigned to one interface can be considered. In addition, one wireless part may be shared among multiple connection modes to switch over at such a speed that the change does not pose any problem from the standpoint of the network interface or maintain a logical link by layer 2 so that it can operate in the same way as the case of the connection to the network from a network part through the two or more interfaces.

<Selection of CoAs to be Paired>

This specification describes efficient processing when the number of CoAs is odd. However, since it is not always true that all the CoAs the MN 1 has (will have) are not suited for being paired, the CoAs need sorting out. For example, in the embodiment used in a highly trusted network, pairing is done based on the high reliability of the communication network, but it is not always true that all the interfaces 11, 12, 13, and 14 of the MN 1 are connected to such a network or all CNs 3 belong to such a network. Further, the reliability state of the network to which the MN 1 is attached may change before or after handover. In such a case, there is a need to predetermine only CoAs connecting to the highly trusted network to be sorted out and paired, or the RR procedure to be performed on CNs 3 attached to networks other than the highly trusted network. Further, in the case of one-way communications, a send CoA and a receive CoA are paired, but if the number of either kind of CoAs is larger than that of the other, the normal RR may have to perform on some (or all) of remaining CoAs. In addition, CoAs used by-directionally must be removed from candidates to be paired. Further, the highly trusted network may be mixed up with one-way communications or other communications (to which the present invention is applicable). In such a case, appropriate pairing and the RR performed by a conventional method must be sorted out.

<Others>

This specification takes as an example a case where the number of pairs of CoAs is mostly two (four CoAs), but it may be one pair (two CoAs) or many. Further, the description (including the drawings) is made on condition that pairing BUs are primarily put together into a bulk BU, but paring BUs performed on a pair basis can also be used without problems. Further, as mentioned above, the BU can be performed on respective CoAs individually, or they may be combined. In addition, the bulk BU method for putting paired BUs together into the bulk BU is not limited to that described in this specification, and any other method can be employed.

FIG. 4 shows a functional block 1100 implementing the RR procedure of the present invention in the MN 1 and the CN 3. The functional block 1100 has one or more network interfaces 1110, a routing unit 1120, and an upper layer 1130. The network interface 1110 is a functional block having all hardware and software necessary for communication with other nodes through a communication medium. The network interface 1110 represents a communication device, firmware, a driver, and layer 1 (physical layer) and layer 2 (data link layer) communication protocols. It will be apparent to those skilled in the art that the functional block 1100 includes one or more network interfaces 900.

The routing unit 1120 determines to which program in the upper layer 1130 or to which interface in the network interface 1110 a packet should be routed. The routing unit 1120 executes a layer 3 (network layer) protocol such as the Internet protocol version 4 or 6. The routing unit 1120 can forward the packet to the network interface 1110 or receive the packet from the network interface 1110 through a signal/data path 1192. Similarly, the routing unit 1120 can forward the packet to the upper layer 1130 or receive the packet from the upper layer 1130 through a signal/data path 1194.

The upper layer 1130 executes all protocols and programs above the network layer in a communication stack. The protocols include transport layer and session layer protocols, such as Transmission Control Protocol (TCP) and Stream Control Transport Protocol (SCTP). The above programs include programs and software necessary to communicate with other nodes. Packets can be forwarded between the routing unit 1120 and the upper layer 1130 through the signal path 1194.

In the routing unit 1120, a routing table 1140 for storing routing entries and a mobility support module 1150 are provided. The mobility support module 1150 enables mobility support for the MN 1 and enables the CN 3 to communicate with the MN 1 in a route optimized manner. Each entry in the routing table 1140 includes information for routing a packet to a destination having a specific prefix, usually including the next hop address to which the packet is forwarded or a network interface identifier.

An RR module 1160 in the mobility support module 1150 exchanges messages according to the RR procedure, and in the embodiment, it tracks information on multiple CoAs. This information is stored in a binding update list (BUL) in the case of the MN 1 or a binding cache entry (BCE) in the case of the CN 3. In FIG. 4, it is shown as a BUL/BCE 1170 in the mobility support module 1150. This information includes CoAs for the CoTi/CoT messages, and related nonces and cookies.

Each of the functional blocks used in describing the aforementioned embodiment of the present invention is implemented as an LSI (Large Scale Integration) typified by an integrated circuit. These may be made up of one chip individually, or they may be made up of one chip to include some or all of them. Here, although the LSI is assumed, it may be called an IC (Integrated Circuit), a system LSI, a super LSI, or an ultra LSI depending on the degree of integration. Further, the technique for creation of an integrated circuit is not limited to LSI, and it may be implemented by a private circuit or a general-purpose processor. An FPGA (Field Programmable Gate Array) capable of programming after LSI manufacturing or a reconfigurable processor capable of reconfiguring connections or settings of circuit cells within the LSI may also be employed. In addition, if integrated circuit technology capable of replacing LSI emerges with the development of semiconductor technology or another technology derived therefrom, the technology may of course be used to integrate the functional blocks. For example, applications of biotechnology may be possible.

### INDUSTRIAL APPLICABILITY

The present invention has the advantage of reducing the number of messages handled in an RR procedure for performing authentication between a mobile node and a peer communication node, and can be used in Monami6 or the like.

1-32. (canceled)

33. A communication method in which a peer communication node authenticates a mobile node having one or more interfaces with a care-of address assigned to each of the one or more interfaces, the method being characterized by comprising:
a step where the mobile node pairs two or more care-of addresses assigned respectively to the one or more interfaces, and sends the peer communication node one or more first messages including a second care-of address by setting a first care-of address in each pair of care-of addresses as a source address;
a step where the peer communication node receives the one or more first messages, generates signature tokens for the first and second care-of addresses, and sends one or more second messages including the generated signature tokens to the second care-of address of the mobile node;
a step where the mobile node generates one or more authentication codes for the two or more care-of addresses using each signature token in the one or more second messages, and sends the peer communication node the two or more care-of addresses and the one or more authentication codes through one or more binding update messages; and
a step where the peer communication node authenticates the one or more authentication codes for the two or more care-of addresses in the one or more binding update messages.

34. The communication method according to claim 33, characterized in that
the mobile node generates a common key for the first and second care-of addresses using each of the signature tokens for the first and second care-of addresses in the second messages, generates a common authentication code for the first and second care-of addresses using the common key, and sends the peer communication node a pairing binding update message including the first and second care-of addresses and the common authentication code, and
the peer communication node authenticates the common authentication code for the first and second care-of addresses in the pairing binding update message.

35. The communication method according to claim 33, characterized in that
the mobile node generates a common key for the two or more care-of addresses using each of the signature tokens in the two or more second messages, generates a common authentication code for the two or more care-of addresses using the common key, and sends the peer communication node a bulk binding update message including the two or more care-of addresses and the common authentication code, and
the peer communication node authenticates the common authentication code for the two or more care-of addresses in the bulk binding update message.

36. A communication system in which a peer communication node authenticates a mobile node having one or more interfaces with a care-of address assigned to each of the one or more interfaces, the system being characterized by comprising:
means for causing the mobile node to pair two or more care-of addresses assigned respectively to the one or more interfaces, and send the peer communication node one or more first messages including a second care-of address by setting a first care-of address in each pair of care-of addresses as a source address;
means for causing the peer communication node to receive the one or more first messages, generate signature tokens for the first and second care-of addresses, and send one or more second messages including the generated signature tokens to the second care-of address of the mobile node;
means for causing the mobile node to generate one or more authentication codes for the two or more care-of addresses using each signature token in the one or more second message, and send the peer communication node the two or more care-of addresses and the one or more authentication codes through one or more binding update messages; and
means for causing the peer communication node to authenticate the one or more authentication codes for the two or more care-of addresses in the one or more binding update messages.

37. A mobile node having one or more interfaces with a care-of address assigned to each of the one or more interfaces in a communication system in which a peer communication node authenticates the mobile node, the mobile node being characterized by comprising:
means for pairing two or more care-of addresses assigned respectively to the one or more interfaces, and sending the peer communication node one or more first messages including a second care-of address by setting a first care-of address in each pair of care-of addresses as a source address; and
means for, when receiving, at the second care-of address from the peer communication node, one or more second messages including signature tokens for the first and second care-of addresses generated based on the one or more first messages, generating one or more authentication codes for the two or more care-of addresses using each signature token in the one or more second messages, and sending the peer communication node the two or more care-of addresses and the one or more authentication codes through one or more binding update messages.

38. The mobile node according to claim 37, characterized in that, upon sending the first messages, paring of the first and second care-of addresses is stored, and when receiving the second message destined to the second care-of address, the first care-of address is derived from the pairing stored.

39. The mobile node according to claim 37, characterized in that, upon sending the first message, paring of the first and second care-of addresses is embedded in a care-of address cookie, and when receiving the second message destined to the second care-of address, the first care-of address is derived from the pairing embedded in the care-of address cookie.

40. The mobile node according to claim 37, characterized in that, when the number of assigned two or more care-of addresses is odd, a third care-of address left as a remainder after pairing is paired with the first or second care-of address previously paired.

41. The mobile node according to claim 40, characterized in that a bulk binding update message in which the third care-of address is grouped with the first or second care-of address previously paired is sent.

42. The mobile node according to claim 37, characterized in that, when the number of assigned two or more care-of addresses is odd, a standard return routability procedure is performed without paring a third care-of address left as a remainder after pairing.

43. The mobile node according to claim 42, characterized in that a bulk binding update message in which the third care-of address is grouped with the first or second care-of address previously paired is sent.

44. The mobile node according to claim 37, characterized in that the first care-of address is a send care-of address used only when the mobile node sends to the peer communication node, and the second care-of address is a receive care-of address used only when the mobile node receives from the peer communication node.

45. The mobile node according to claim 44, characterized in that it is described in the binding update message which care-of address is the send care-of address or the receive care-of address.

46. The mobile node according to claim 37, characterized in that, when a care-of address is for an interface connecting to a highly trusted network so that reliability up to the peer communication node is maintained, the care-of address is determined to be paired, and in other cases, a standard return routability procedure is performed without pairing the care-of address.

47. The mobile node according to claim 37, characterized in that the mobile node generates a common key for the first and second care-of addresses using each of the signature tokens for the first and second care-of addresses in the second messages, generates a common authentication code for the first and second care-of addresses using the common key, and sends the peer communication node a pairing binding update message including the first and second care-of addresses and the common authentication code.

48. The mobile node according to claim 37, characterized in that the mobile node generates a common key for the first and second care-of addresses using each of the signature tokens for the first and second care-of addresses in the two or more second messages, generates a common authentication code for the two or more care-of addresses using the common key, and sends the peer communication node a bulk binding update message including the two or more care-of addresses and the common authentication code.

49. The mobile node according to claim 37, characterized in that, when any of the care-of addresses bound in the peer communication node is changed or when a new care-of address is assigned, the mobile node sends a binding update message including the changed care-of address or the new care-of address, and other care-of addresses bound in the peer communication node.

50. A communication node as a peer communication node in a communication system in which the peer communication node authenticates a mobile node having one or more interfaces with a care-of address assigned to each of the one or more interfaces, the communication node being characterized by comprising:
means for receiving one or more first messages sent from the mobile node after the mobile node pairs two or more care-of addresses assigned respectively to the one or more interfaces, setting a first care-of address in each pair of care-of addresses as a source address, and including a second care-of address in the one of more first messages;
means for generating signature tokens for the first and second care-of addresses based on the one or more first messages received, and sending one or more second messages including the generated signature tokens to the second care-of address of the mobile node;
means for receiving one or more binding update messages sent from the mobile node after the mobile node generates one or more authentication codes for the two or more care-of addresses using each signature token in the one or more second messages, and including the two or more care-of addresses and the one or more authentication codes in the one or more binding update messages; and
means for authenticating the one or more authentication codes for the two or more care-of addresses in the one or more binding update messages received.

51. The communication node according to claim 50, characterized in that, when receiving the one or more first messages and generating the signature tokens for the first and second care-of addresses, the communication node generates first and second signature tokens based on the first and second care-of addresses.

52. The communication node according to claim 50, characterized in that the first care-of address is described in the second message.

53. The communication node according to claim 50, characterized by further comprising:
means for receiving a pairing binding update message sent from the mobile node after the mobile node generates a common key for the first and second care-of addresses using each of the signature tokens for the first and second care-of addresses in the second messages, generating a common authentication code for the first and second care-of addresses using the common key, and including, in the pairing binding update message, the first and second care-of addresses and the common authentication code; and
means for authenticating the common authentication code for the first and second care-of addresses in the pairing binding update message.

54. The communication node according to claim 50, characterized by further comprising:
means for receiving a bulk binding update message sent from the mobile node after the mobile node generates a common key for the two or more care-of addresses using each of the signature tokens for the first and second care-of addresses in the two or more second messages, generating a common authentication code for the two or more care-of address using the common key, and including, in the bulk binding update message, the two or more care-of address and the common authentication code; and
means for authenticating the common authentication code for the two or more care-of address in the bulk binding update message.

55. The communication node according to claim 50, characterized by further comprising:
means for authenticating the common authentication code for the two or more care-of address in the bulk binding update message and binding the two or more care-of address to a home address of the mobile node;
means for, when one or more care-of addresses in the two or more care-of addresses assigned respectively to the two or more interfaces of the mobile node is changed, or when a care-of address is newly assigned to another interface of the mobile node, receiving the first message sent in a manner to include already bound care-of addresses by setting the new care-of address as the source address; and
means for binding the new care-of address to a home address of the mobile node based on the first message.
